(19) United States
(12) Patent Application Publication
(10) Pub. No.: US 2024/0353529 A1
(43) Pub. Date: Oct. 24, 2024

(54) INTEGRATION OF VIRTUAL CHANNELS FROM DOPPLER DIVISION MULTIPLEX (DDM) FMCW RADAR SIGNAL

(71) Applicant: Infineon Technologies AG, Neubiberg (DE)

(72) Inventors: Dyson Wilkes, Marlborough (GB); Moustafa Samy Abdelkhalek Ahmed Emara, Bristol (GB); David Addison, Bristol (GB)

(21) Appl. No.: 18/404,133

(22) Filed: Jan. 4, 2024

Related U.S. Application Data
(63) Continuation-in-part of application No. 18/304,585, filed on Apr. 21, 2023.

(51) Int. Cl. G01S 7/35; G01S 7/288; G01S 13/58

(52) U.S. Cl. CPC G01S 7/356; G01S 7/2883; G01S 13/584

(57) ABSTRACT

Some aspects of the present disclosure relate a radar system including a radio frequency (RF) receiver that receives radar data on a plurality of receive antennas. A fast Fourier transform (FFT) circuit is coupled to the RF receiver. The FFT circuit performs a FFT on the radar data to provide a plurality of Range-Doppler coordinate pairs that pertain to the plurality of receive antennas. An integration block is coupled to the FFT circuit, and sums multiple Range-Doppler coordinate pairs for respective Doppler bins to provide a plurality of Range-Doppler sums. The integration block also sums multiple Range-Doppler sums within the plurality of Range-Doppler sums to provide an integration result. The multiple Range-Doppler coordinate pairs that are summed are spaced apart from one another by a Doppler offset.

### REFERENCE TO RELATED APPLICATION

This application claims priority to U.S. patent application Ser. No. 18/304,585 filed on Apr. 21, 2023, the contents of which are hereby incorporated by reference in their entirety.

### FIELD

The present disclosure relates in general to electronic systems such as radar systems, and more particularly, to radar systems that utilize Doppler division multiplexing in frequency modulated continuous wave radar.

### BACKGROUND

Radar (RAdio Detection And Ranging) systems use radio waves to determine the location and/or velocity of targets in a field. Historically, radar has been used to detect aircraft, ships, spacecraft, guided missiles, and terrain, among others. In more recent times, radar has also been used to study and/or predict weather formations, and has been used in collision-detection and/or collision-avoidance in motor vehicles. A radar system includes a transmitter to produce electromagnetic waves in the radio or microwave domain, a receiver to receive those waves after they bounce back from one or more targets in a field, and a processor to determine properties of the targets. The electromagnetic waves from the transmitter can be pulsed or continuous, and reflect off the target and return to the receiver, giving information about the target's location and/or velocity relative to the radar system.

### BRIEF DESCRIPTION OF THE DRAWINGS

FIG. 1 illustrates a frequency-time plot for a transmitted waveform and received waveforms used in a frequency modulated continuous wave (FMCW) radar system.

FIG. 2 illustrates a voltage-time plot for the transmitted waveform and received waveforms of FIG. 1.

FIG. 3 illustrates a FMCW radar system in accordance with some aspects of the present disclosure.

FIGS. 4A and 4B illustrate a series of drawings that depict integration of virtual receivers for the FMCW radar system of FIG. 3.

FIG. 4C illustrates an integration block and detector in accordance with some embodiments.

FIGS. 5A-5B illustrate hardware components of an integration circuit in accordance with some aspects of the present disclosure.

FIGS. 6A-6B illustrate a timing diagram consistent with integration of FIGS. 4A and 4B, and with the integration circuit of FIG. 5A.

FIG. 7A illustrates hardware components of a FMCW radar system in accordance with some aspects of the present disclosure.

FIG. 7B illustrates some examples of how pipelining can occur in a FMCW radar system in accordance with some aspects of the present disclosure.

FIG. 8 illustrates hardware components of another FMCW radar system in accordance with some aspects of the present disclosure.

FIG. 9 illustrates a method in flow chart format according to some aspects of the present disclosure.

### DETAILED DESCRIPTION

The present disclosure will now be described with reference to the attached drawing figures, wherein like reference numerals are used to refer to like elements throughout, and wherein the illustrated structures and devices are not necessarily drawn to scale. As utilized herein, terms “component,” “system,” “interface,” and the like are intended to refer to a computer-related entity, hardware, software (e.g., in execution), and/or firmware.

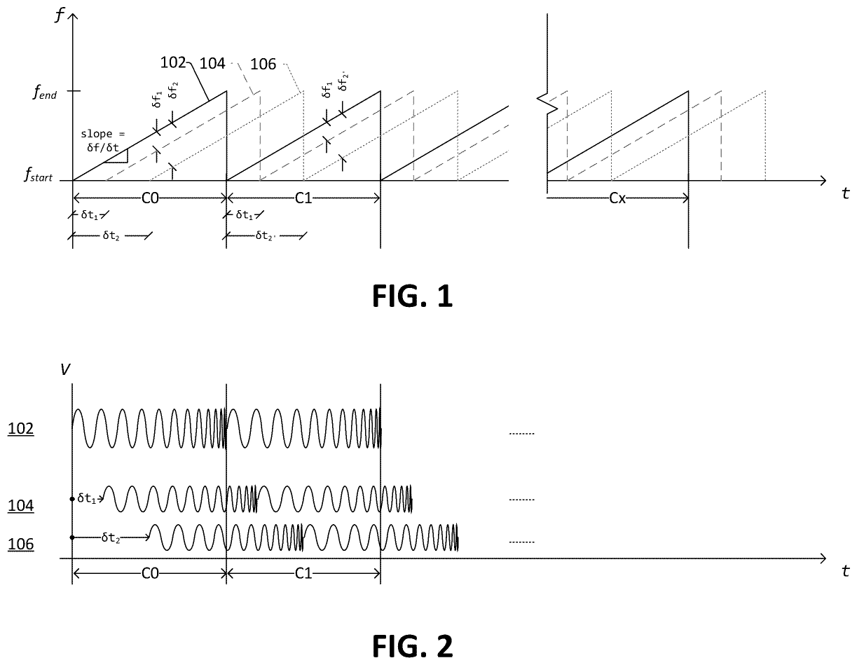

Radar systems transmit electromagnetic waves in the form of discrete pulses or continuous waves, and then listen for received pulses (or echoes) to determine the location and/or velocities of targets in a field. For example, FIG. 1 shows an example of a simple transmitted waveform 102 transmitted by a frequency modulated continuous wave (FMCW) radar system, and two received waveforms (or echoes) 104, 106 that reflect back from various targets in the field. It will be appreciated that these waveforms are merely non-limiting examples, and actual waveforms can take any number of forms.

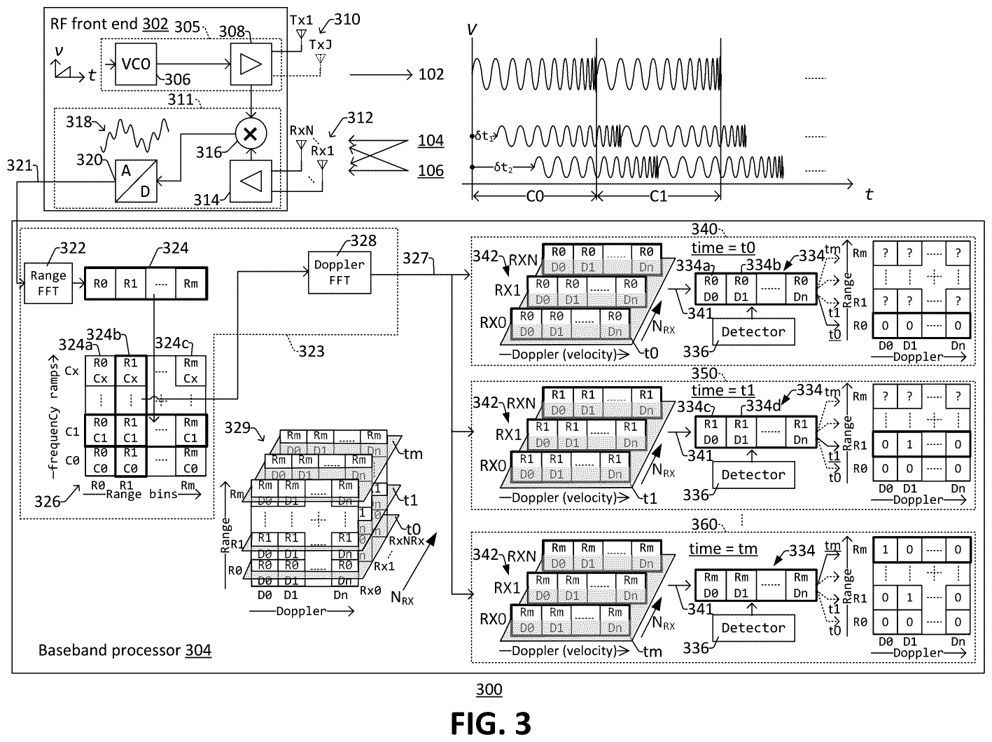

The transmitted waveform 102 includes a series of ramps or “chirps”, which are transmitted so as to be repeated at regularly spaced time windows C0, C1, C2, . . . , Cx. FIG. 1 shows the instantaneous frequency of the chirps versus time, while FIG. 2 shows the corresponding modulated voltage signals of the chirps as they are transmitted in the corresponding time windows C0, C1, . . . . Each ramp starts at the beginning of a given time window at a start frequency Fₛₜₐᵣₜ and ramps up or down to an end frequency F_{end} at the end of the given time window. Ideally, each ramp has a constant slope during that time window, which provides a link between time delay, beat frequency, and range for various targets in the FMCW radar system. In actual implementations, the slope may not be perfectly constant and may vary slightly in time.

The received waveforms 104, 106 or “echoes” are in response to the transmitted waveform 102. The received waveforms 104, 106 are time delayed copies of the transmitted waveform 102 and also carry a Doppler component due to the relative velocity of the target from which they reflect. Thus, for example, in FIG. 1 and FIG. 2, the first received waveform 104 is reflected from a first target at Range 1 and is delayed relative to the transmitted pulse by a first delay, δt1 for the first time window C0. Similarly, the second received waveform 106 is reflected from a second target at Range 2 and is delayed relative to the transmitted waveform 102 by a second delay, δt2 for the first time window C0. Because these time delays δt1, δt2 represent the roundtrip delay from the transceiver to the first and second targets in the field, these time delays form the basis of determining the first and second ranges to the first and second targets, respectively.

Further, for later time windows, if the targets are moving, the delay and/or frequency difference at a given time between the transmitted waveform 102 and the received waveforms (e.g., 104, 106) may change slightly, and this can evidence the velocity of various targets. For instance, for the first and second time windows, consider the first target is a first range from the transceiver and corresponds to the first delay, δt1 (and equivalently a first frequency shift δf1). Because this first delay, δt1, is unchanged in the first and second time windows, it suggests that the first target is at the same range at both times (e.g., and has zero relative velocity), relative to the radar transceiver. However, the second target has a second delay δt2 for the first time window and has a slightly perturbed delay δt2′ (which differs slightly from the second delay δt2) for the second time window. Therefore, this small change between δt2 and δt2′ manifests itself as a Doppler shift for the second target, and suggests the second target is moving with some non-zero velocity relative to the radar transceiver. Note that, relative to the duration of a given time window, the lengths of the time delays δt1, δt2 are exaggerated in FIG. 1 and FIG. 2 for purposes of clarity of understanding.

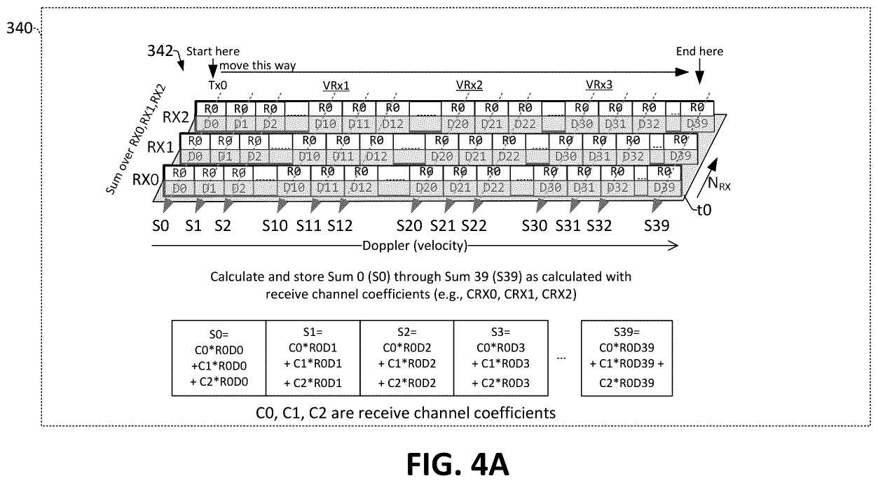

FIG. 3 illustrates a FMCW radar transceiver 300 in accordance with some embodiments, and which can make use of FMCW waveforms such as described in FIGS. 1-2. The transceiver 300 includes a radio frequency (RF) front end 302 and a baseband processor 304 downstream of the RF front end 302. The illustrated RF front end 302 illustrates a transmission path 305 and a reception path 311, though multiple transmission paths and/or reception paths are typically present. The transmission path 305 includes a voltage controlled oscillator (VCO) 306, and a transmission amplifier 308, and is coupled to J transmission antennas 310 (wherein J is any positive integer). The reception path 311 is coupled to N reception antennas 312 (N=any positive integer), and includes a reception amplifier 314, a mixer 316, and an analog-to-digital converter (ADC) 320. The reception antennas 312 are typically spaced apart at equal distances from one another.

During operation, the transmission path 305 generates a transmitted waveform 102 for example using the VCO 306. In the illustrated example, the transmitted waveform 102 has a frequency that ramps in time for x ramps transmitted in x time windows, respectively. The transmitted waveform is achieved by performing a frequency modulation of a carrier frequency, Fc, such that the instantaneous frequency of the transmitted waveform 102 varies from fₛₜₐᵣₜ to f_{end}. The transmitter transmits the waveform 102 using the transmission amplifier 308 and transmission antennas 310.

The received waveforms or “echoes” (e.g., 104 and 106) are received by the reception antennas 312 and the reception amplifier 314. Because each target in the field generates a different echo, each reception antenna 312 sees a superposition of all received waveforms. The mixer 316 mixes the transmitted waveform 102 and the received waveforms 104, 106 and thereby multiplies these waveforms together to provide a mixed signal 318. This mixed signal 318 includes a beat frequency, which is a mixture of the frequencies of the received waveforms (e.g., δf1 and δf2). Thus, this beat frequency corresponds to time delays for the various targets, and wherein these time delays correspond to the ranges to the various targets, respectively. The beat frequency is much less than the carrier frequency, Fc; or the central frequency of the sweep. The beat frequency is then sampled by the ADC 320 to generate a digital radar signal 321.

In the baseband processor 304, a signal processing unit 323 includes a fast Fourier transform (FFT) circuit to perform a first FFT 322 and a second FFT 328. In some embodiments, the first FFT 322 and second FFT 328 correspond to separate FFT circuit instantiations arranged in series on an integrated circuit, and which collectively correspond to the FFT circuit. In other embodiments, however, first FFT 322 and second FFT 328 can be a single FFT circuit with surrounding circuitry to re-route data through the single FFT circuit multiple times to achieve the data processing illustrated in FIG. 3. In either case, the result is that the first FFT—or Range FFT 322—is initially performed on the digital radar signal 321. The Range FFT 322 separates the individual beat frequencies in the digital radar signal 321, which directly leads to a first FFT result 324 with a number of range bins, with each range bin corresponding to a different range of ranges/distances in which objects can be found. This FFT process is repeated over every ramp of x ramps (e.g., from ramp C0 . . . to ramp Cx), and the FFT results are stored in a first memory 326 for each of x ramps. When all the x ramps are complete, a block of data representing the full field range data is stored in the first memory 326. The results in each range bin (e.g., @R1 range bin 324b, which includes a range value for Range R1 for each of the x ramps) may look similar for the various frequency ramps in that range bin, but, since the individual ramps C0, C1, . . . , Cx are separated in time, the samples in a given range bin carry a subtle phase difference induced by the Doppler shift of the various objects (e.g., a time delay due to a slight change in range for an object caused by the object moving by distance v*t, where v is the velocity of the object and t is time).

To recover Doppler information (e.g., velocity information about each object), the second FFT 328—or “Doppler FFT”—is performed on the co-located bins (represents the corner turn or transpose operation) from all ramps. The Doppler information is stream of complex values transmitted on bus 327 and stored in memory 342. Each complex value represents the magnitude (amplitude) and phase of the digital radar signal 321 at a respective range and Doppler coordinate pair. Note that in preferred embodiments the stream of complex values on 327 is not simply a two-dimensional range-Doppler map but has a third dimension and may thus be thought of as a 3D radar cube 329 having Range axis, Doppler axis, and a receive antennas axis (Nrx). Thus, the 3D radar cube 329 stored in memory 342 includes received powers from various objects in a field, and can be plotted according to range bins, Doppler bins; and NRx receive antennas.

Accordingly, in some embodiments of the present disclosure, the Doppler FFT block 328 individually processes a plurality of single range bins in a plurality of timeslots, respectively, wherein each single range bin pertains to a single range bin with multiple Doppler bins and multiple Rx antennas. To improve processing speed, results of the Doppler FFT block 328 are stored in memory 342, which is coupled to the signal processing circuit 323 via a first bus 327. A second bus 341 couples the memory 342 to an integration circuit 334, and the second bus 341 can also couple the memory 342 to a Direct Memory Access (DMA) that is included in or coupled to the detector 336 and/or integration circuit 334, such that the integration circuit 334 and/or detector 336 can read and write data from the memory 342 without continually hand-holding from a processor.

Whereas other approaches would process the entire 3D radar cube 329 only after the entire 3D radar cube 329 is stored, the present techniques do not require the entire 3D radar cube to be stored before starting processing and can be thought of in some regards as processing individual horizontal “slices” of such a 3D cube during respective timeslots (e.g., a first horizontal “slice” corresponding to a first Range R0 324a processed during a first timeslot t0 in 340; a second horizontal “slice” corresponding to a second Range R1 324b processed during a second timeslot t1 in 350; . . . ; and an mth horizontal “slice” corresponding to a mth Range Rm 324c processed during an mth timeslot in 360). Because the Doppler FFT block 328 writes only Range-Doppler coordinate pairs of a single Range bin to memory 342 during any given timeslot, successive Doppler FFT results pertaining to different ranges can use the same memory 342 (and can overwrite the previous Doppler FFT results in that memory array for each time slot). In this way, this technique significantly reduces the amount of memory required for the system. This technique also facilitates pipelining of various downstream operations including detection of the various targets in an efficient manner.

For instance, in 340, during first time slot t0; the Doppler FFT block 328 outputs the stream of complex values such that a first plurality of Range-Doppler coordinate pairs sharing a first range value 324a (e.g., R0) are output to memory 342. Thus, the resultant output of the Doppler FFT block 328 for the first time slot to is stored in memory 342 with each column corresponding to a different Doppler shift (velocity) (e.g., D0, D1, . . . , Dn), and each row corresponding to a different receive antenna (Rx0, Rx1, . . . , RxN). In some cases, the size of the memory 342 corresponds to the number of Doppler bins times the number of receive antennas (e.g., (n+1)*(N+1)).

Similarly, in 350, during a second time slot t1, the Doppler FFT block 328 processes a second single range bin 324b (e.g., R1) over the multiple receive antennas (Rx0, Rx1, . . . , RxN). Thus, the resultant output of the Doppler FFT for the second time slot t1 is stored in the memory 342 with each column corresponding to a different Doppler shift (velocity) (e.g., D0, D1, . . . , Dn), and each row corresponding to a different receive antenna (Rx0, Rx1, . . . , RxN). In some cases, the data for the second time slot is written to the same memory 342 where the data of the first timeslot is written, and the data of the second timeslot overwrites the data of the first timeslot. In other cases, memory 342 can be larger, such that data is not overwritten.

Similarly, in 360, during an mth time slot tm, the Doppler FFT block 328 processes an mth single range bin 324c (e.g., Rm) over the multiple receive antennas (Rx0, Rx1, . . . , RxN). Thus, the resultant output of the Doppler FFT for the mth time slot tm is stored in the memory 342 with each column corresponding to a different Doppler shift (velocity) (e.g., D0, D1, . . . , Dn), and each row corresponding to a different receive antenna (Rx0, Rx1, . . . , RxN). Again, in some cases, the data for the mth time slot is written to the same memory 342 where the data from the first and second timeslots are written, and the data of the mth timeslot overwrites the data of the first and/or second timeslot.

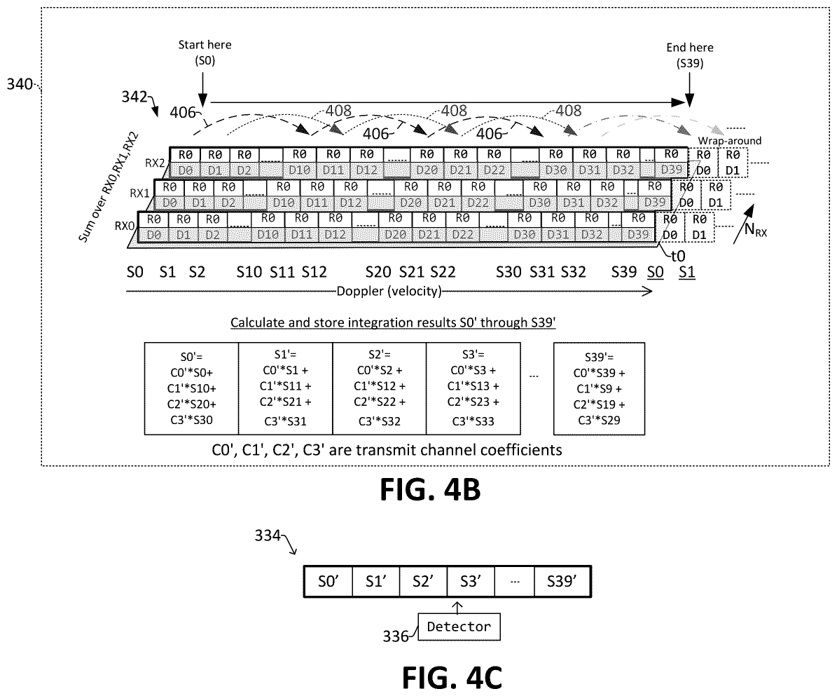

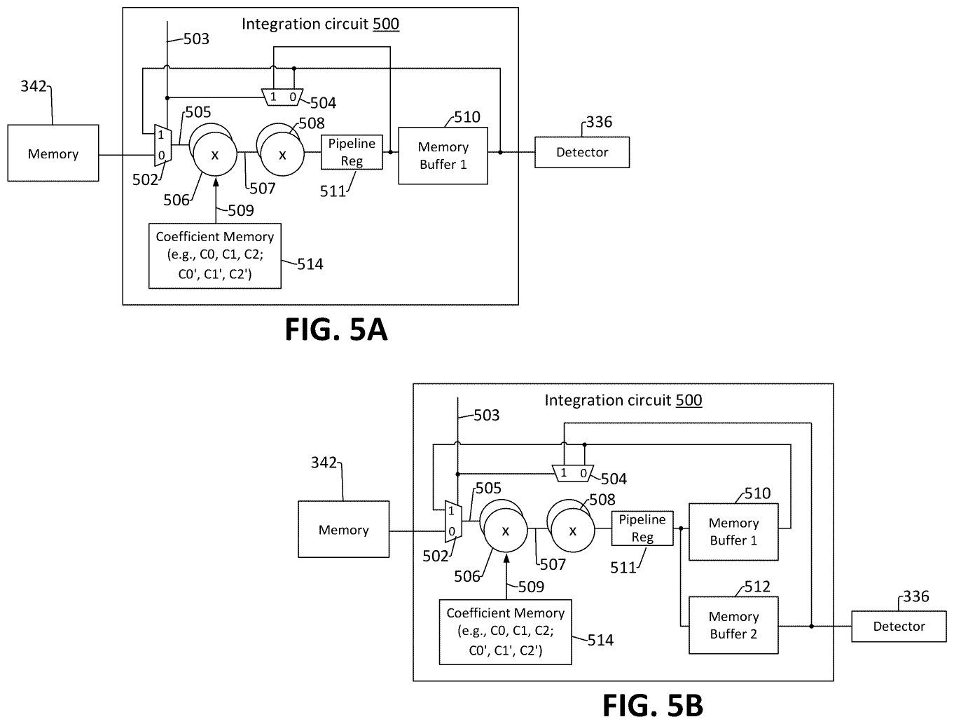

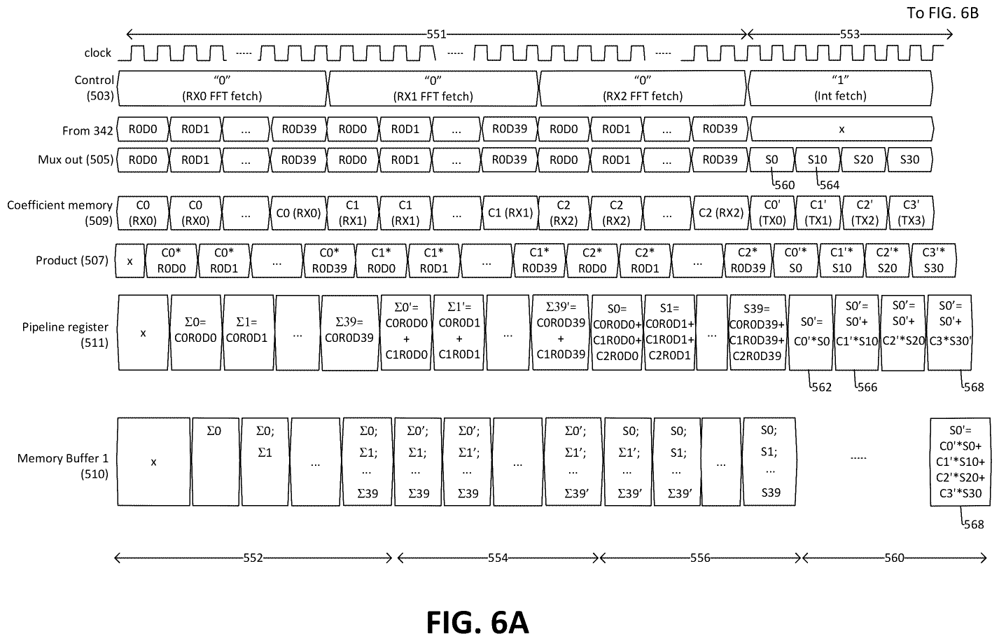

For each timeslot, the diversity from multiple antennas is combined in an integration block 334 coupled to the memory 342 via a second bus 341. The integration block 334 has an input coupled to the memory 342. Thus, during operation, the output of the integration block 334 provides Range-Doppler sums (e.g., resultant power intensities) for each Range-Doppler bin in successive timeslots. For example, a first Range-Doppler sum 334a is determined for R0, D0; a second Range-Doppler sum 334b is determined for R0, D1; a third Range-Doppler sum 334c is determined for R1, D0; a Range-Doppler sum 334d is determined for R1, D1; and so on. More detailed examples of this integration are discussed below with regards to FIGS. 4A-4B, and FIGS. 5A-5B.

Then, a detector 336 (which has an input that is coupled to an output of the integration block 334) performs processing to determine whether the detected Range-Doppler sums from the integration block 334 represent actual targets or phantom targets for each Range-Doppler coordinate pair. For example, at time tm in 360, as indicated by the “1”s in the radar map, a first actual target has been detected at Range Rm, Doppler (velocity) D0, and a second actual target has been detected at Range R1, Doppler (velocity) D1; while “0”s at other locations in the radar map indicate a lack of targets in those bins. The detector 336 can for example be realized as a 1-dimensional constant false alarm rate (CFAR) detector, 2-dimensional CFAR detector, or others. The integration block 334 and detector 336 can be implemented in hardware.

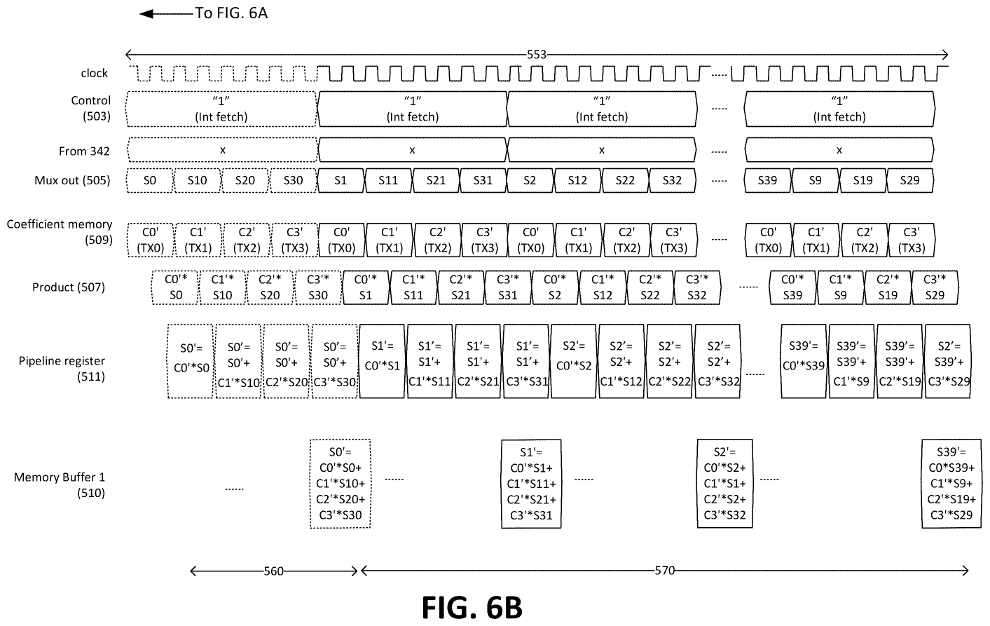

It will be appreciated that while timeslots 340, 350, and 360 depict examples showing how the Doppler FFT block 328 and integration block 334 process single range bins during respective time slots that are separate, these operations can also be pipelined, and thus timeslots 340, 350, and 360 may actually overlap in time in some regards. Some further examples of some ways in which pipelining can be implemented are illustrated and described for example further herein in FIGS. 6A-6B.

FIGS. 4A-4B illustrate a series of drawings that depict integration of virtual receive channels for the FMCW radar system of FIG. 3 (see e.g., 334 and 342 of FIG. 3). Briefly, by performing the integration with a Doppler offset over the various Doppler bins, this integration equates to a rate of phase modulation of the transmitted signal and by virtue of an appropriate physical separation of the Tx antenna, can be considered to be one or more virtual receive channels. In general, the total number of virtual receive channels equals JTx*NRx. FIGS. 4A-4C illustrate an example where there are forty Doppler bins (D0, . . . , D39), three reception antennas (RX0, RX1, and RX2, so N=3), and a four transmission antennas (J=4), though other numbers of Doppler bins, reception antennas and/or transmission antennas could be used in other instances. Thus, in this example, there are twelve virtual receivers with an equal Doppler bin spacing (e.g., of 10 Doppler bins), which is a simplification of other cases where an unequal Doppler bin spacing could be used. Thus, in other embodiments, some virtual receivers can be spaced apart by a first Doppler offset, and other virtual receivers can be spaced apart by a second Doppler offset that differs from the first Doppler offset. In some embodiments, the number of expected transmission and/or reception channels can be programmable to accommodate multiple different implementations of a Radar system, such that the integration block (e.g., 334 of FIG. 3, or 514 of FIG. 5A) may include a programmable register that can be set by a central processing unit (CPU), Direct-Memory-Access (DMA) unit, or other system component.

In FIG. 4A, during a first portion of the first timeslot 340, the integration block 334 sums the complex values for each Doppler bin over all receive antennas to determine a plurality of Range-Doppler sums (S0, S1, . . . , S39). Thus, for first Doppler bin (D0), the integration block 334 multiples a first complex value for R0, D0 on RX0 by a first receive channel coefficient (C0); multiples a second complex value for R0,D0 on RX1 by a second receive channel coefficient (C1); and multiples a third complex value for R0, D0 on RX2 by a third receive channel coefficient (C2). These products are then summed to generate a first Range-Doppler sum SO (e.g., S0=C0*R0D0 (RX0)+C1*R0D0 (RX1)+C2*R0D0 (RX2)). For second Doppler bin (D1), the integration block 334 multiples a first complex value for R0,D1 on RX0 by the first receive channel coefficient (C0); multiples a second complex value for R0,D1 on RX1 by the second receive channel coefficient (C1); and multiples a third complex value for R0, D1 on RX2 by the third receive channel coefficient (C2); and then these products are summed to generate a second Range-Doppler sum S1 (e.g., S1=C0*R0D1 (RX0)+C1*R0D1 (RX1)+C2*R0D1 (RX2)). Additional Range-Doppler sums S2, . . . , S39 are then calculated and stored in a similar fashion.

In FIG. 4B, the integration block 334 determines Range-Doppler integration results to account for the various transmitters and virtual receivers. For example, for the first Doppler bin (D0), the first integration result SO′ is calculated to reflect offsets at the eleventh bin (e.g., S10), twentieth-first bin (e.g., S20), and thirtieth-first bin (e.g., S30)—see arrows 406. Similarly, the second integration result S1′ is calculated to reflect offsets at twelfth bin (e.g., S11), twenty-second bin (e.g., S21), and thirty-second bin (e.g., S31)—see arrows 408; and so on. For later bins, the offsets can “wrap around” the end of the bins—so for example, the fortieth integration result (S39′) can be calculated to reflect offsets at the tenth bin (e.g., S9), twentieth bin (e.g., S19), and thirtieth bin (e.g., S29). More particularly, Range-Doppler integration results S0′, S1′, . . . , S39′ are determined according to equations below, as follows:

$${{{{S 0 ’ = C 0 ’}^{*} S 0 + C 1 ’}^{*} S 10 + C 2 ’}^{*} S 20 + C 3 ’}^{*} S 30 ; \qquad ( 1 )$$

$${{{{S 1 ’ = C 0 ’}^{*} S 1 + C 1 ’}^{*} S 11 + C 2 ’}^{*} S 21 + C 3 ’}^{*} S 31 ; \qquad ( 2 )$$

$$…$$

$${{{{S 39 ’ = C 0 ’}^{*} S 39 + C 1 ’}^{*} S 9 + C 2 ’}^{*} S 19 + C 3 ’}^{*} S 29 ; \qquad ( 40 )$$

In the equations above, C0′ is a first transmit channel coefficient; C1′ is a second transmit channel coefficient; C2′ is a third transmit channel coefficient; and C3′ is a fourth transmit channel coefficient. Transmit channel coefficients C0′, C1′, C2′, and C3′ are typically different from one another, and are also different from the receive channel coefficients C0, C1, C2, and C3. Thus, the end result of the integration in this example is a vector with forty elements (S0′, S1′, . . . . S39′).

In FIG. 4C (similar to detector 336 of FIG. 3), the detector 336 then performs processing to determine whether the final vector including the Range-Doppler integration results (S0′, S1′, . . . , S39′) represent a null target, an actual target, or a phantom target for each of the first Range-Doppler coordinate pairs. For example, the detector 336 determines whether respective potential targets are present in the first range value (R0) and respective Doppler values based on the whether the respective final integration results (e.g., power intensities) are greater than a predetermined threshold. Additional times (e.g., timeslots 350 and 360 from FIG. 3) with additional ranges can also be processed in an analogous manner, and detection can also be performed to detect potential targets at those ranges. It will be appreciated that the integration results can be stored in one or more memory buffers, which can include random access memories (RAM), registers, first-in-first-out (FIFO) memories, last-in-first-out memories (LIFO) memories, and/or other types of memory. These memory buffers can be written to by a general processor or by custom logic arranged in the processing path of the radar system; and can be included in and/or accessed by the integration circuit 334.

FIG. 5A shows a more detailed schematic of an integration circuit 500 according to some examples. Integration circuit 500 can correspond to some examples consistent with integration circuit 334 of FIGS. 3 and/or 4A-4B. The integration circuit 500 includes a first multiplexer 502, a second multiplexer 504, a multiplier 506, an adder 508, a first memory buffer 510, and a coefficient memory 514. In some examples, these components can manifest as logic gates (e.g., transistors) as part of an integrated circuit on one or more silicon die or other semiconductor die(s), while in other examples these components can be implemented as software instructions running on a processor, such as a digital signal processor and/or baseband processor.

The first multiplexer 502 includes a first input, second input, and an output. The first input of the first multiplexer is coupled to the memory 342. The multiplier 506 has a first input coupled to the output of the first multiplexer 502, and has a second input coupled to the coefficient memory 514. The adder 508 has a first input coupled to an output of the multiplier 506, and has a second input coupled to an output of the second multiplexer 504. A pipeline register 511 has an input coupled to the output of the adder 508. The first memory buffer 510 has an input coupled to the output of the pipeline register 511. The first memory buffer 510 has an output that is coupled to the second input of the first multiplexer 502 and that is coupled to the first input of the second multiplexer 504. The output of the first memory buffer 510 is also coupled to input of detector 336. Control terminals of the first and second multiplexers 502, 504 are coupled together, and receive a control signal via a control circuit, such as a microcontroller or finite state machine logic. Also, the input (labeled as memory 342 in FIG. 5A) does not have to be a memory, but could also be an output from an FFT circuit. Furthermore the FFT circuit can output its data in bit-reversed addressing order (usual for some FFT implementations). The order of the data does not matter (note that the same coefficient is applied for all bins in the RX integration). The re-ordering to linear address ordering can be achieved by storing the SO sums in their appropriate locations in the memory buffer 342.

FIG. 5B is similar to FIG. 5A, but also includes a second memory buffer 512. The second memory buffer 512 has an input coupled to the output of the pipeline register 511, and has an output coupled to the second input of the second multiplexer 504 and coupled to the input of the detector 336.

The sum of products (e.g., as performed by 506 and 508) may be done either in the complex domain (coherent integration) or the power domain (non-coherent integration). In coherent integration the input data and coefficients are both complex (real, imaginary), while in non-coherent integration the power of each bin of FFT data is first calculated and the coefficients are only real. In the case of coherent integration, the power of the result is calculated before detection.

FIGS. 6A-6B illustrate an integration operation consistent with some examples of FIG. 5A's integration circuit 500. The integration operation includes a first portion 551 whereby range-Doppler sums are determined (e.g., consistent with FIG. 4A); and includes a second portion of time 553 of FIG. 6A and continuing over to FIG. 6B whereby the various range-Doppler sums are integrated according to one or more offsets to account for virtual receivers (e.g., consistent with FIG. 4B).

During time 552, Range-Doppler data corresponding to the first receive antenna (Rx0) initially arrives from memory buffer 342. During this time 552, a multiplexer control bit 503 is set to 0, such that the Range-Doppler data corresponding to the first receive antenna (Rx0) is passed to the output 505 of the first multiplexer 502 and first input of multiplier 506. During time 552, an output 509 of coefficient memory 514 passes coefficient C0, which corresponds to the first receive antenna, to the second input of multiplier 506. Hence, the multiplier 506 provides a series of products on 507 that represent the Range-Doppler data multiplied by the first receive channel coefficient; and the pipeline register 511 briefly stores these products. The products are also tabulated and stored in the first memory buffer 510. At the end of time 552, for each Doppler bin, an initial Range-Doppler value (Σ0; Σ1; . . . Σ39) corresponding to the first receive antenna Rx0 is stored in the first memory buffer 510 (analogous to FIG. 4A, where a first component of sum SO is equal to Range-Doppler values for Rx0).

During time 554, the same process is again carried out, but during this time the Range-Doppler data corresponds to the second receive antenna (Rx1) and the output 509 of coefficient memory 514 passes second receive channel coefficient C1, which corresponds to the second receive antenna, to the second input of multiplier 506. Again, the products are tabulated and stored in the pipeline register 511. This time, however, the sum in the first memory buffer 510 includes the previous sum for a given Range-Doppler bin, plus the new product. For example, for range-Doppler bin (R0-D0) during 554, the first memory buffer 510 is updated to store Σ0′=C0R0D0+C1R0D0 (analogous to FIG. 4A, where the first two components of SO are equal to the sum of Range-Doppler values for Rx0 and Rx1). Thus, at the end of 554, updated Range-Doppler summation values (Σ0′; Σ1′; . . . ; Σ39′) are stored in first memory buffer 510.

During time 556, the same process is again carried out, but during this time the Range-Doppler data corresponds to the third receive antenna (Rx2) and the coefficient memory 514 passes third receive channel coefficient C2, which corresponds to the third receive antenna, to the second input of multiplier 506. Again, the products are tabulated and stored in the pipeline register 511. This time the sum in first memory buffer510 again includes the previous sum for a given Range-Doppler bin, plus the new product. For example, for range-Doppler bin (R0-D0) during 554, the first memory buffer 510 is updated to store S0=C0R0D0+C1R0D0+C2R0D0 (e.g., analogous to FIG. 4A, where S0 is equal to the sum of Range-Doppler values for Rx0, Rx1, and Rx2). Thus, the end of time 556 corresponds to FIG. 4A, where each of the sums S0 through S39 are determined and stored in first memory buffer 510.

Next during time 553, an integration is carried out whereby virtual receivers are accounted for (e.g., analogous to FIG. 4B). To facilitate integration, the multiplexer control is set to 1, and the relevant sums are retrieved from the first memory buffer 510 and multiplied with the transmitter channel coefficients (C0′, C1′, C2′, C3′, respectively). For example, during the integration for the first Range-Doppler bin S0, the pipeline register 511 starts with S0 at 560 (e.g., analogous to FIG. 4A), then multiplies S0 with the first transmission coefficient C0′ to get a first initial integration result S0′ at 562. Then, at 564 the S10 is multiplied by the second transmission coefficient C1′ to get a second initial integration result, which is then summed with the first initial integration result at 566. This continues for S20 and S30, until a first final integration result S0′ is determined at 568. Other bins are processed, output, and/or stored in the same manner (see e.g., 570), until all virtual receivers are accounted for. The target detector 336 performs target detection using the integration results S0′, S1′, . . . , S39′. The stored results, if present, can be read by the detector circuit as necessary.

Notably, in FIGS. 6A-6B, the Doppler-Range complex data typically arrives from the FFT block so Range-Doppler data (e.g., R0, D0 through R0, D39) from the first RX antenna (Rx0) arrives first (e.g., during 552), then the Range-Doppler data (e.g., R0,D0-R0,D39) from the second RX antenna (Rx1) arrives next (e.g., during 554). Finally, the Range-Doppler data (e.g., R0,D0 through R0,D39) from the last RX antenna (RxN, where N=2 in FIGS. 4A-4B and FIG. 5) arrives last (e.g., during 556). Because the manner in which the integration circuit is structured, this Range-Doppler data from the FFT block is processed in a very streamlined manner whereby data is processed in the same order as it arrives during the RX fetch stage in 551. Moreover, because the Range-Doppler sums (S0, S1, . . . , S39) are determined and stored during 551, the integration results determined in 553 are also efficient in terms of processing. Thus, this scheme allows fast/efficient processing of radar data that can provider higher performance and/or lower power than other approaches. Furthermore, the order of the data from the FFT block is unimportant and can be in bit-reversed or linear addressing order.

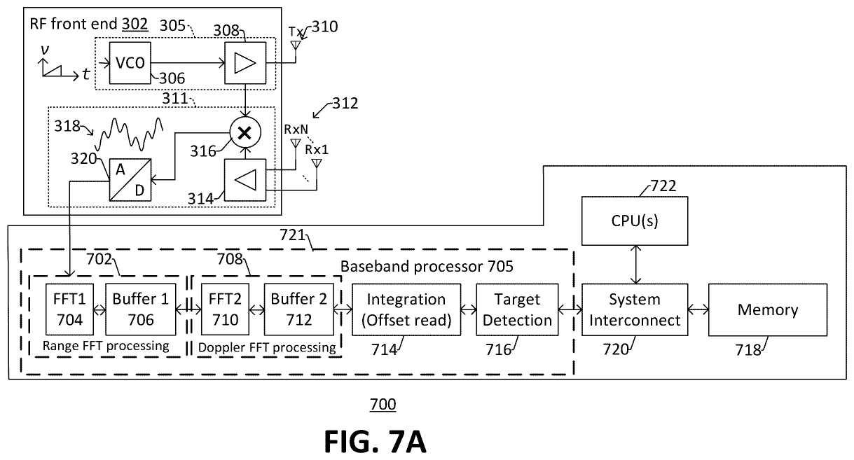

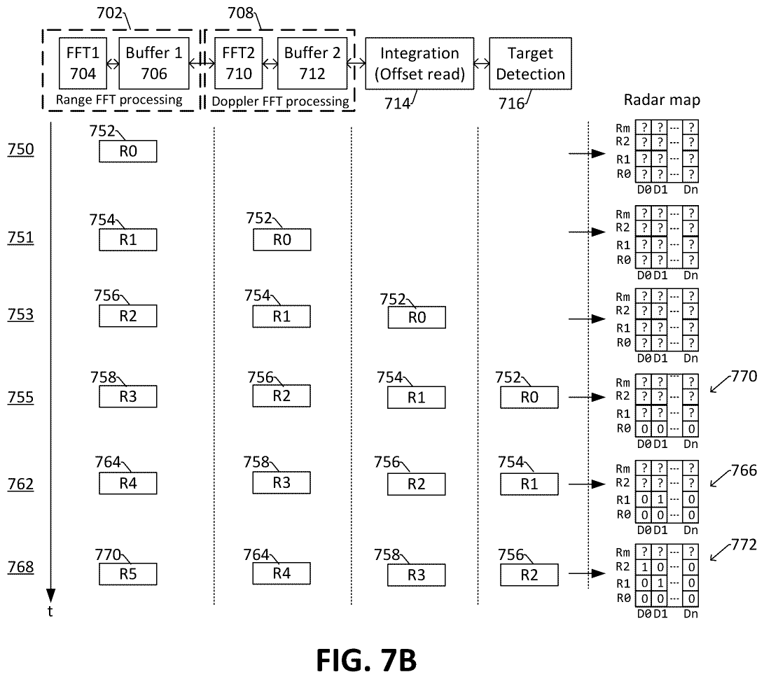

FIG. 7A shows some embodiments of a radar transceiver 700 in accordance with the present disclosure. The radar transceiver 700 includes an RF front end 302 as previously described, and baseband processor 705. The baseband processor 605 includes a first fast-Fourier transform (FFT) circuit 604, a second FFT circuit 710, an integration block 714, and a target detection block 716, which are arranged in series with one another. A first buffer 706 is coupled between the first FFT circuit 704 and the second FFT circuit 710, and a second buffer 712 is arranged between the second FFT circuit 710 and the integration block 714. One or more system memory blocks 718 (which can also be distributed at different points in the baseband processor in some cases), one or more central processing units (CPUs) 722, and a system interconnect 720 (which couples the CPUs to the memory blocks and/or the radar processing circuitry 721 to the CPU and/or memory blocks) are also included in the baseband processor. Other components, such as Direct-Memory-Access (DMA) blocks, additional buffers, and the like, can also be included as appropriate. In some embodiments, all circuit elements of the baseband processor 705 are fashioned on a single silicon substrate, while in other embodiments, a first subset of the circuit elements are formed on one silicon substrate and a second subset of the circuit elements are formed on another silicon substrate. For example, in some cases, the radar processing circuitry 721 can be located on one silicon substrate, and the system memory blocks 718, system interconnect 720, and/or CPUs 722 can be located on another silicon substrate. Other variations also fall within the present disclosure.

The first FFT circuit 704 and first buffer 706 are configured to perform range FFT processing, such as previously described in 322-326 and corresponding text of FIG. 3, for example. The second FFT circuit 710 and second buffer 712 are configured to perform Doppler FFT processing, such as previously described in 328 and corresponding text of FIG. 3, for example. The integration block 714 can be configured to perform integration, including integration of virtual receivers, such as previously described in FIGS. 4A-4C, FIG. 5, and FIGS. 6A-6B, for example.

FIG. 7B shows a conceptual diagram of some examples of how pipelined processing can be carried out in the baseband processor 705 of FIG. 7A to update a Radar map in time. In FIG. 7B, the y axis of the page corresponds to time, and the x-axis is vertically aligned to show what the various components of the baseband processor of FIG. 7A are processing during each time. Neither of these axes is necessarily drawn to scale.

During a first time 750, a first FFT result 752 corresponding to Range 0 is processed by the first FFT circuit 704, and written to the first buffer 706. In some cases, the first FFT circuit 704 corresponds to the Range FFT 322 of FIG. 3, and the first buffer 706 corresponds to the first memory 326 of FIG. 3.

During a second time 751, the first FFT result 752 is processed by the second FFT circuit 710, and at the same time, a second FFT result 754 corresponding to Range 1 is processed by the first FFT circuit 704.

During a third time 753, the first FFT result 752 is processed by the integration block 714, and at the same time, the second FFT result 754 is processed by the second FFT circuit 710, and a third FFT result 756 corresponding to Range 2 is processed by the first FFT circuit 704.

During a fourth time 755, the first FFT result 752 is processed by the target detection block 716, and at the same time, the second FFT result 754 processed by the integration block 714, the third FFT result 756 is processed by the second FFT circuit 710, a fourth FFT result 758 corresponding to Range 3 is processed by the first FFT circuit 704. When the first FFT result 752 is processed by the target detection block 716, the radar map can be updated at time 760 to reflect whether targets are selected for the various Doppler bins of Range 0. In the illustrated example, zeros are shown to indicate that no targets are detected in the various Doppler bins of Range 0, but other conventions could also be used.

During a fifth time 762, the second FFT result 754 is processed by the target detection block 716, and at the same time, the third FFT result 756 is processed by the integration block 714, the fourth FFT result 758 is processed by the second FFT circuit 710, and a fifth FFT result 764 corresponding to Range 4 is processed by the first FFT circuit 704. When the second FFT result 754 is processed by the target detection block 716, the radar map can be updated at time 766 to reflect whether targets are detected for the various Doppler bins of Range 1. In the illustrated example, a one is shown at D1, R1 to indicate a target is detected at distance/range R1 and having a velocity corresponding to D1; while other Doppler/Range bins are each “zero” to indicate no other targets are detected in the other Doppler bins of range 1.

During a sixth time 768, the third FFT result 756 is processed by the target detection block 716, and at the same time, the fourth FFT result 758 is processed by the integration block 714, the fifth FFT result 664 is processed by the second FFT circuit 610, and a sixth FFT result 770 corresponding to Range 5 is processed by the first FFT circuit 704. When the third FFT result 756 is processed by the target detection block 716, the radar map can be updated at time 772 to reflect whether targets are detected for the various Doppler bins of Range 2. In the illustrated example, “1”s are shown at D1, R1 and D0, R2 to indicate targets are detected at these Ranges/Velocities; while other Doppler/Range bins are each filled with “0” to indicate no other targets are detected in the other Doppler bins of range 2.

Thus, as can be appreciated from FIG. 7B, arranging second FFT circuit 710, second buffer 712, integration block 714, and target detection block 716 in series with one another allows for efficient pipelining operations to be carried out. For example, compared to other approaches where range processing block 702 processes an entire 3D radar cube, and then Doppler processing block 708 (which includes second FFT circuit 710, and second buffer 712) performs a second FFT on the 3D radar cube; the pipelining of FIG. 7B allows for the Doppler FFT, integration, and target detection to occur in a much more efficient manner so the radar map can be processed and/or updated more quickly. This also allows post-processing (e.g., target processing) to start sooner and complete sooner than previous approaches.

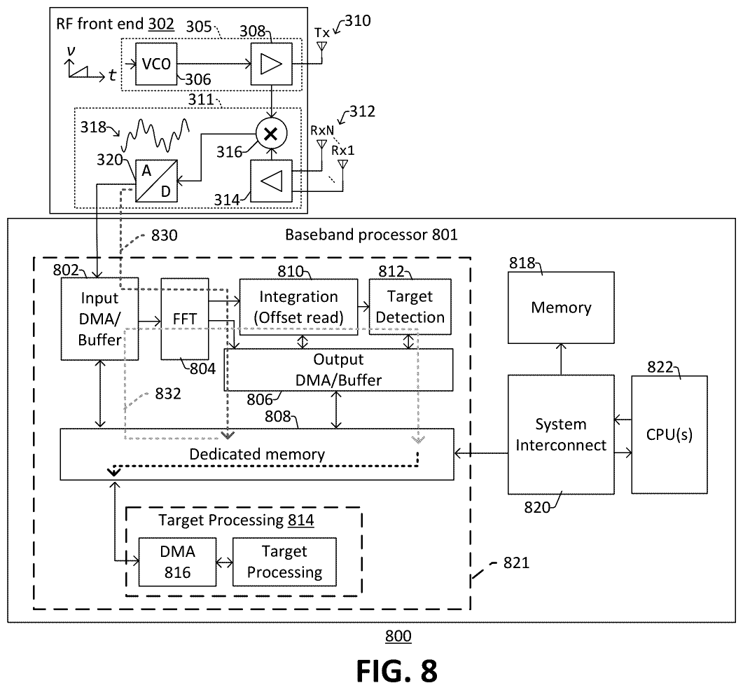

FIG. 8 shows some embodiments of another radar transceiver 700 in accordance with the present disclosure. The baseband processor 801 in this radar transceiver 800 includes an input DMA/buffer 802, FFT block 804, output DMA/buffer 806, dedicated memory 808, integration block 810, and target detection unit 812—all of which are implemented in hardware and operably coupled to one another via bus structures as shown. A target processing circuit 814, which is coupled to the dedicated memory 808 via a DMA 816; as well as one or more memory block(s) 818, CPU(s) 822 and system interconnect 820 are also included, and can be operably coupled as shown. In some embodiments, all circuit elements of the baseband processor 801 are fashioned on a single silicon substrate, while in other embodiments, a first subset of the circuit elements are formed on one silicon substrate and a second subset of the circuit elements are formed on another silicon substrate. For example, in some cases, the radar processing circuitry 821 can be located on one silicon substrate, and the memory block(s) 818, system interconnect 820, and/or CPU(s) 822 can be located on another silicon substrate. Other variations also fall within the present disclosure.

Compared to the radar transceiver of FIG. 7A where all hardware circuit components were arranged entirely in series, in the radar transceiver 800 of FIG. 8, the first fast-Fourier transform (FFT) function and second FFT function are both implemented within a single FFT hardware block 804 in FIG. 8. Thus, the circuitry of the baseband processor 801 is configured to route digital radar data through the baseband processor 801 in multiple rounds of pipelining. In a first round of the pipelining, the input DMA/buffer 802 passes data from the ADC 320 to the FFT block 804 (now acting as a Range FFT block), and the Range FFT result is then written to dedicated memory 808 via output DMA/buffer 806 (see arrow 830). In a second round of the pipelining, the input DMA/buffer 802 passes the data output from the first round (stored in dedicated memory 808) back to the FFT block 804 (now acting as a Doppler FFT block), to the integration block 810, and then to the target detection block, 812 which are again arranged in series with one another, before the output DMA/buffer 806 writes the result to dedicated memory 808 (see arrow 832). The integration block 810 can be configured to perform integration, including integration of virtual receivers, such as previously described in FIGS. 4A-4B for example. Although FIG. 7A and FIG. 8 depict some examples of hardware architectures for radar transceivers, it will be appreciated that other hardware architectures for radar transceivers are also contemplated as falling within the scope of the present disclosure, and these are merely non-limiting examples.

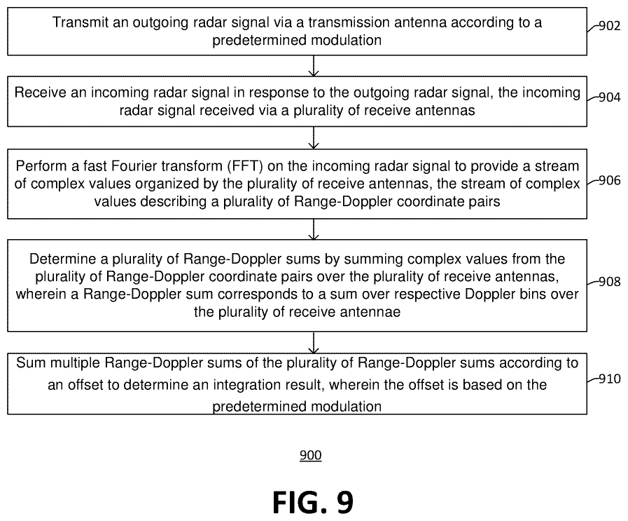

FIG. 9 depicts a method 900 in accordance with some aspects of this disclosure.

In block 902, an outgoing radar signal is transmitted via a transmission antenna according to a predetermined modulation.

In block 904, an incoming radar signal is received in response to the outgoing radar signal. The incoming radar signal is received via a plurality of receive antennas.

In block 906, a fast Fourier transform (FFT) on the incoming radar signal to provide a stream of complex values organized by the plurality of receive antenna. The stream of complex values describes a plurality of Range-Doppler coordinate pairs.

In block 908, a plurality of Range-Doppler sums is determined by summing complex values from the plurality of Range-Doppler coordinate pairs over the plurality of receive antennas. A Range-Doppler sum corresponds to a sum over respective Range-Doppler bins over the plurality of receive antennas. For example, in FIG. 4A, a first Range-Doppler sum S0 is determined by finding a product of R0-D0 bins multiplied by their respective receive antenna coefficients, and then summing those products; a second Range-Doppler sum S1 is determined in a similar way, and so on.

In block 910, multiple Range-Doppler sums of the plurality of Range-Doppler sums are summed according to an offset. The offset is based on the predetermined modulation. For example, in FIG. 4B, Range-Doppler sums are summed with an offset of 10, such that Range-Doppler sum S0′ is determined by summing S0 and S10; S1′ is determined by summing S1 and S11; and so on.

Thus, some aspects of the present disclosure relate to a method including receiving an incoming radar signal in response to an outgoing radar signal. The incoming radar signal is received via a plurality of receive antennas. A fast Fourier transform (FFT) is performed on the incoming radar signal to provide a stream of complex values describing a plurality of Range-Doppler coordinate pairs. A plurality of Range-Doppler sums (e.g., S0, S1, . . . , S39) are determined by summing complex values from the stream of complex values, wherein a Range-Doppler sum (e.g., S0) corresponds to a sum over the plurality of receive antennas (e.g., Rx0-Rx2) for a Range-Doppler bin (e.g., D0). An integration result (e.g., S0″) is determined by summing multiple Range-Doppler sums (e.g., S0″=S0+S10+S20) of the plurality of Range-Doppler sums, wherein the multiple Range-Doppler sums that are summed to provide the integration result are spaced apart from one another by an offset (e.g., 10 Doppler bin offset).

In some examples, the outgoing radar signal is transmitted via a transmission antenna according to a predetermined modulation, and the offset is based on the predetermined modulation.

In some examples, the multiple Range-Doppler sums that are summed include a first Range-Doppler sum and a second Range-Doppler sum, wherein the offset is a first number of Doppler bins separating the first Range-Doppler sum from the second Range-Doppler sum.

In some examples, the multiple Range-Doppler sums that are summed include a third Range-Doppler sum, wherein the first number of Doppler bins also separates the second Range-Doppler sum from the third Range-Doppler sum.

In some examples, the method further includes determining whether a target is present based on the integration result.

In some examples, determining the plurality of Range-Doppler sums includes multiplying Range-Doppler values for the plurality of receive antennas by a plurality of coefficients, respectively, for the plurality of receive antennas, respectively.

Some examples pertain to a radar system that includes a radio frequency (RF) receiver configured to receive radar data via a plurality of receive antennas. A fast Fourier transform (FFT) circuit is coupled to the RF receiver. The FFT circuit is configured to perform a FFT on the radar data to provide a plurality of Range-Doppler coordinate pairs. An integration block is coupled to the FFT circuit. The integration block is configured to sum multiple Range-Doppler coordinate pairs for respective Doppler bins to provide a plurality of Range-Doppler sums, and is further configured to sum multiple Range-Doppler sums within the plurality of Range-Doppler sums to provide an integration result, wherein the multiple Range-Doppler coordinate pairs that are summed are spaced apart from one another by a Doppler offset.

In some examples, the radar system further includes a target detector coupled to the integration block and configured to determine whether a target is present based on the integration result.

In some examples, the integration block includes: a first multiplexer having a first input, a second input, and an output, the first input of the first multiplexer coupled to the FFT circuit; a multiplier having a first input, a second input, and an output, the first input of the multiplier coupled to the output of the first multiplexer; and an adder having a first input, a second input, and an output, the first input of the adder coupled to the output of the multiplier, and the output of the adder coupled to an input of the target detector.

In some examples, the integration block is configured to sum a first subset of Range-Doppler coordinate pairs each having a first Doppler value within the plurality of Range-Doppler sums to provide a first Range-Doppler sum, and sum a second subset of Range-Doppler coordinate pairs each having a second Doppler value within the plurality of Range-Doppler sums to provide a second Range-Doppler sum.

In some examples, the first Doppler value is spaced apart from the second Doppler value by the Doppler offset.

In some examples, the integration block is configured to sum the first Range-Doppler sum and the second Range-Doppler sum to provide the integration result.

In some examples, the integration block is further configured to sum a third subset of Range-Doppler coordinate pairs each having a third Doppler value within the plurality of Range-Doppler sums to provide a third Range-Doppler sum, and sum the first, second, and third Range-Doppler sums to provide the integration result.

In some examples, the first Doppler value and second Doppler value are spaced apart from one another by the Doppler offset, and the second Doppler value and third Doppler value are spaced apart from one another by the Doppler offset.

In some examples, the radar system is a frequency modulated continuous wave (FMCW) radar system.

Still other examples pertain to a radar system that includes a radio frequency (RF) receiver including a plurality of receive antennas, a fast Fourier transform (FFT) circuit coupled to the RF receiver; a target detector coupled to the FFT circuit; and an integration block coupled between the FFT circuit and the target detector. The integration block includes a first multiplexer having a first input, a second input, and an output. The first input of the first multiplexer is coupled to the FFT circuit. A multiplier has a first input, a second input, and an output, where the first input of the multiplier is coupled to the output of the first multiplexer. An adder has a first input, a second input, and an output. The first input of the adder is coupled to the output of the multiplier, and the output of the adder is coupled to an input of the target detector.

In some examples, the radar system further includes a coefficient memory configured to store a plurality of coefficients for the plurality of receive antennas, respectively; wherein the second input of the multiplier is coupled to the coefficient memory.

In some examples, the integration block further comprises: a second multiplexer having a first input, a second input, and an output, the first input of the second multiplexer is coupled to the output of the adder, and the output of the second multiplexer is coupled to the second input of the adder.

In some examples, the second input of the first multiplexer is coupled to the output of the adder.

In some examples, the radar system is a frequency modulated continuous wave (FMCW) radar system.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description and the claims, such terms are intended to be inclusive in a manner similar to the term “comprising”.

What is claimed is:

1. A method, comprising:
receiving an incoming radar signal in response to an outgoing radar signal, the incoming radar signal received via a plurality of receive antennas;
performing a fast Fourier transform (FFT) on the incoming radar signal to provide a stream of complex values describing a plurality of Range-Doppler coordinate pairs;
determining a plurality of Range-Doppler sums by summing complex values from the stream of complex values, wherein a Range-Doppler sum corresponds to a sum over the plurality of receive antennas for a Range-Doppler bin; and
determining an integration result by summing multiple Range-Doppler sums of the plurality of Range-Doppler sums, wherein the multiple Range-Doppler sums that are summed to provide the integration result are spaced apart from one another by an offset.

2. The method of claim 1, wherein the outgoing radar signal is transmitted via a transmission antenna according to a predetermined modulation, and the offset is based on the predetermined modulation.

3. The method of claim 1, wherein the multiple Range-Doppler sums that are summed include a first Range-Doppler sum and a second Range-Doppler sum, wherein the offset is a first number of Doppler bins separating the first Range-Doppler sum from the second Range-Doppler sum.

4. The method of claim 3, wherein the multiple Range-Doppler sums that are summed include a third Range-Doppler sum, wherein the first number of Doppler bins also separates the second Range-Doppler sum from the third Range-Doppler sum.

5. The method of claim 3, further comprising:
determining whether a target is present based on the integration result.

6. The method of claim 1, wherein determining the plurality of Range-Doppler sums includes multiplying Range-Doppler values for the plurality of receive antennas by a plurality of coefficients, respectively, for the plurality of receive antennas, respectively.

7. A radar system:
a radio frequency (RF) receiver configured to receive radar data via a plurality of receive antennas;
a fast Fourier transform (FFT) circuit coupled to the RF receiver, the FFT circuit configured to perform a FFT on the radar data to provide a plurality of Range-Doppler coordinate pairs;
an integration block coupled to the FFT circuit, the integration block configured to sum multiple Range-Doppler coordinate pairs for respective Doppler bins to provide a plurality of Range-Doppler sums, and further configured to sum multiple Range-Doppler sums within the plurality of Range-Doppler sums to provide an integration result, wherein the multiple Range-Doppler coordinate pairs that are summed are spaced apart from one another by a Doppler offset.

8. The radar system of claim 7, further comprising:
a target detector coupled to the integration block and configured to determine whether a target is present based on the integration result.

9. The radar system of claim 8, wherein the integration block comprises:
a first multiplexer having a first input, a second input, and an output, the first input of the first multiplexer coupled to the FFT circuit;
a multiplier having a first input, a second input, and an output, the first input of the multiplier coupled to the output of the first multiplexer; and
an adder having a first input, a second input, and an output, the first input of the adder coupled to the output of the multiplier, and the output of the adder coupled to an input of the target detector.

10. The radar system of claim 7, wherein the integration block is configured to sum a first subset of Range-Doppler coordinate pairs each having a first Doppler value within the plurality of Range-Doppler sums to provide a first Range-Doppler sum, and sum a second subset of Range-Doppler coordinate pairs each having a second Doppler value within the plurality of Range-Doppler sums to provide a second Range-Doppler sum.

11. The radar system of claim 10, wherein the first Doppler value is spaced apart from the second Doppler value by the Doppler offset.

12. The radar system of claim 10, wherein the integration block is configured to sum the first Range-Doppler sum and the second Range-Doppler sum to provide the integration result.

13. The radar system of claim 10, wherein the integration block is further configured to sum a third subset of Range-Doppler coordinate pairs each having a third Doppler value within the plurality of Range-Doppler sums to provide a third Range-Doppler sum, and sum the first, second, and third Range-Doppler sums to provide the integration result.

14. The radar system of claim 13, wherein the first Doppler value and second Doppler value are spaced apart from one another by the Doppler offset, and the second Doppler value and third Doppler value are spaced apart from one another by the Doppler offset.

15. The radar system of claim 7, wherein the radar system is a frequency modulated continuous wave (FMCW) radar system.

16. A radar system:
a radio frequency (RF) receiver including a plurality of receive antennas;
a fast Fourier transform (FFT) circuit coupled to the RF receiver;
a target detector coupled to the FFT circuit; and
an integration block coupled between the FFT circuit and the target detector, the integration block comprising:
a first multiplexer having a first input, a second input, and an output, the first input of the first multiplexer coupled to the FFT circuit;
a multiplier having a first input, a second input, and an output, the first input of the multiplier coupled to the output of the first multiplexer; and
an adder having a first input, a second input, and an output, the first input of the adder coupled to the output of the multiplier, and the output of the adder coupled to an input of the target detector.

17. The radar system of claim 16, further comprising:
a coefficient memory configured to store a plurality of coefficients for the plurality of receive antennas, respectively; wherein the second input of the multiplier is coupled to the coefficient memory.

18. The radar system of claim 16, wherein the integration block further comprises:
a second multiplexer having a first input, a second input, and an output, the first input of the second multiplexer coupled to the output of the adder, and the output of the second multiplexer coupled to the second input of the adder.

19. The radar system of claim 16, wherein the second input of the first multiplexer is coupled to the output of the adder.

20. The radar system of claim 16, wherein the radar system is a frequency modulated continuous wave (FMCW) radar system.
